(19) United States
(12) Patent Application Publication
(10) Pub. No.: US 2017/0134162 A1
(43) Pub. Date: May 11, 2017

(54) SYSTEM AND PROCESS FOR VERIFYING DIGITAL MEDIA CONTENT AUTHENTICITY

(71) Applicants: Shannon Code, Raleigh, NC (US); Sean Dennis, Earnley (GB); Gregory Simon, Beaufort, NC (US)

(72) Inventors: Shannon Code, Raleigh, NC (US); Sean Dennis, Earnley (GB); Gregory Simon, Beaufort, NC (US)

(21) Appl. No.: 15/402,216

(22) Filed: Jan. 9, 2017

Related U.S. Application Data
(60) Provisional application No. 62/253,679, filed on Nov. 10, 2015.

(51) Int. Cl. H04L 9/06; G06F 21/10; H04L 9/32; G06F 21/53

(52) U.S. Cl. CPC H04L 9/0637; G06F 21/53; G06F 21/10; H04L 9/0643; H04L 9/3239; G06F 2221/034; G06F 2221/0775

(57) ABSTRACT

A system and process for securing digital media file content for persistence is disclosed. Aspects of the system and process protect content from being altered or embedded with malicious code during distribution through a network. A digital media file is embedded with a hash function. In some embodiments, successive frames may be hashed. A copy of the hash function may be retrieved from a trusted source which may be located within a distributed ledger network. Copies of the digital media file and hash function are checked at network member nodes to verify authenticity of the content. During verification, the media file may be checked to verify if successive frames (for example 2 or more) comply with the trusted hash function. Metadata for authenticated media files may provide trusted information about the original media file.

### CROSS-REFERENCE TO RELATED APPLICATION

This application claims benefit under 35 U.S.C. §119(e) of U.S. Provisional Application having Ser. No. 62/253,679 filed Nov. 10, 2015, which is hereby incorporated by reference herein in its entirety.

### FIELD

The subject disclosure relates to digital file security, and more particularly to a system and process for verifying digital media content authenticity.

### BACKGROUND

Currently digital media can be modified from the original content after a change of custody. It is difficult to determine if a given digital media file is the exact original content since the previous owner may have modified the contents unbeknownst to the new owner. The problem is particularly acute in distributed network environments where multiple copies of a media file may exist and are persisted amongst several different computer/server systems. Each copy is susceptible to being modified at a waypoint in the network path from the source to the end destination. Thus, multiple copies of the file may have a change(s) that can persist geometrically the more a file is distributed within the network.

As can be seen, there is a need for a system and process that can track media files and their content to verify the content of a media file is authentic or unmodified.

### SUMMARY

In one aspect of the disclosure, a method for verifying the authenticity of digital media file content, comprises hashing a plurality of frames of an original, unaltered digital media file to generate a plurality of hash values associated with the original, unaltered digital media file; generating a hash chain from the hashed plurality of frames, the hash chain associated with the original, unaltered digital media file; storing the generated hash chain in a distributed ledger network; hashing a digital media file copy; receiving a copy of the stored hash chain from the distributed ledger network; comparing the hashed digital media file copy with the received copy of the stored hash chain from the distributed ledger network; determining whether the hashed digital media file copy matches the received copy of the stored hash chain from the distributed ledger network; and verifying an authenticity of the hashed digital media file copy as an unaltered copy of the original, unaltered file.

In another aspect of the disclosure a computer program product for verifying the authenticity of digital media file contents comprises a non-transitory computer readable storage medium having computer readable program code embodied therewith. The computer readable program code is configured to: hash a plurality of frames of an original, unaltered digital media file to generate a plurality of hash values associated with the original, unaltered digital media file; generate a hash chain from the hashed plurality of frames, the hash chain associated with the original, unaltered digital media file; store the generated hash chain in a distributed ledger network; hash a digital media file copy; receive a copy of the stored hash chain from the distributed ledger network; compare the hashed digital media file copy with the received copy of the stored hash chain from the distributed ledger network; determine whether the hashed digital media file copy matches the received copy of the stored hash chain from the distributed ledger network; and verify an authenticity of the hashed digital media file copy as an unaltered copy of the original, unaltered file.

In still yet another aspect of the disclosure, a computer server system for verifying the authenticity of digital media file contents comprises a non-transitory computer readable storage medium having computer readable program code. The system further comprises a processing unit configured to, according to the computer readable code: hash a selected digital media file copy; receive a copy of a stored hash chain from a distributed ledger network; compare the hashed digital media file copy with the received copy of the stored hash chain from the distributed ledger network; determine whether the hashed digital media file copy matches the received copy of the stored hash chain from the distributed ledger network; and verify an authenticity of the hashed digital media file copy as an unaltered copy of an original, unaltered file.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a block diagram of a computer/server system for securing a digital media file's contents and verifying the authenticity of contents when the file is transferred in accordance with an aspect of the subject technology.

FIG. 2 is a block diagram of a network for transferring and verifying digital media file content in accordance with an aspect of the subject technology.

FIG. 3 is a flowchart of a method for cryptographically securing digital media file contents in accordance with an aspect of the subject technology.

FIG. 3A is a graphic showing an exemplary hashing process on an audio file in accordance with an aspect of the subject technology.

FIG. 3B is a graphic showing an exemplary hashing process on a multi-part audio file in accordance with an aspect of the subject technology.

FIG. 4 is a flowchart of a method for verifying the authenticity of digital media file contents in accordance with an aspect of the subject technology.

FIG. 5 is a flowchart of a method for identifying authentic digital media files from a distributed ledger network in accordance with an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

Generally, embodiments of the subject technology provide a system and process verifying the authenticity of digital media file contents. Exemplary embodiments incorporate the added benefits from an electronic distributed ledger network to provide security to the authentication process. Embodiments disclosed below generally exist within an electronic online environment. In an exemplary embodiment, a the hash of a digital media file is accessible from a trusted source in a distributed ledger network. Copies of the digital media are hashed and compared against a retrieved copy of the hash from the distributed ledger network. In some embodiments, copies of the digital media file may also be retrieved from the distributed ledger network. However, copies of the digital media file obtained from outside a distributed ledger network may especially benefit from the security provided by embodiments disclosed herein. As may be appreciated, within a network or the Internet in general, there may be many opportunities for third parties to intercept the digital media file while it is in transit to alter the content to deceive the recipient. Conventional video streaming safeguards may use a hash function or Merkle tree approach to verify that the transfer of packets in a direct one-to-one transaction has been uncorrupted. However, there is a problem in that some astute hackers may intercept the single file in transit from the source and may exploit weaknesses in the hash algorithm so that the end recipient is never aware that the file has been corrupted. Aspects of the invention disclosed herein overcome such an attack on a secured media file. In order to overcome the safeguards of the disclosed invention, a hacker would have to alter both multiple copies of the digital media file persisted in the network and the original hashed file, which in some embodiments may exist in multiple servers within the distributed ledger network. As such, any attempt to alter or corrupt even the digital media file can be detected by the system checking against copies in other servers in the distributed ledger network.

A distributed ledger protocol used herein may be for example a blockchain protocol such as, Bitcoin, Ethereum, Ripple or RibbitRewards, a permissioned distributed ledger, a metadata protocol on top of a distributed ledger protocol, such as CounterParty or ColoredCoins, or any other derivation of metadata protocols or distributed ledger protocols.

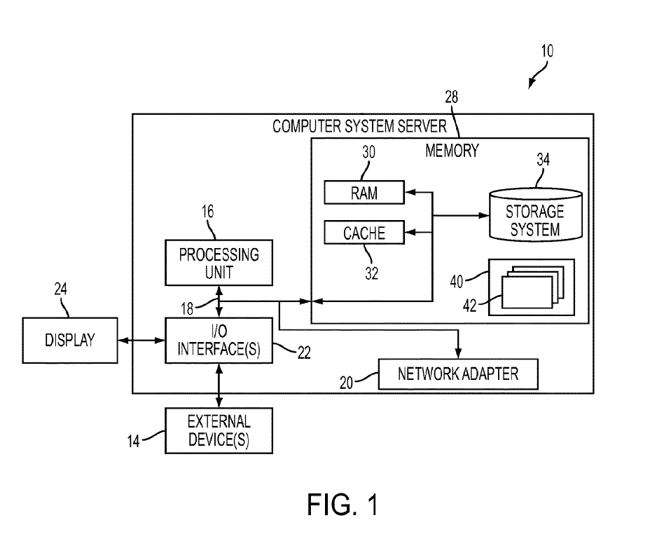

Referring now to FIG. 1, a schematic of an example of a computer system/server 10 is shown. The computer system/server 10 is shown in the form of a general-purpose computing device. As may be appreciated, reference to a computer system/server 10 (sometimes referred to as a “general computing machine”) in the following description may refer to different machines depending on the role or function being performed. In addition, more than one computer system/server 10 may be present simultaneously, for example in the network 100 described more fully below. Each computer system/server 10 may run a copy of a software embodiment described herein. The computer system/server 10 may serve the role as the machine implementing for example functions related to recording, storing and selecting digital media files for chain hashing, generating a hash function algorithm, storing copies of the hash function/hash chains, applying the hash function algorithm to segments or frames of the digital media file, generating data packets with the digital media file or portions thereof integrating the hash function and source/destination information, reading packet information as the digital media file is received at one or more computer systems/servers 10 in a distributed ledger, and verifying/denying that a received digital media file or its portion/frame complies with the hash chain. The components of the computer system/server 10 may include, but are not limited to, one or more processors or processing units 16, a system memory 28, and a bus 18 that couples various system components including the system memory 28 to the processor 16. In some embodiments, hashing functions may be integrated into hardware disclosed. For example, video cards may include a Graphic Processing Units (GPU) which may operate similar to the processing unit 16 and may be particularly good at math operations. Hashing is a math operation and GPU hashing are efficient time wise (fast) and have a lower power cost than using a traditional CPU. Some embodiments may include a dedicated Trusted Platform Module (TPM) with a processing unit 16 which may be used to securely perform cryptographic operations inside a trusted (sandboxed) location within the computer system/server 10.

The computer system/server 10 may be generally be for example, server computer systems, personal computer systems, multiprocessor systems, microprocessor-based systems, network PCs, and distributed cloud computing environments that include any of the above systems or devices, and the like. In some embodiments, the computer system/server 10 may include one or more tablet devices, mobile telephone devices, handheld or laptop devices, smart electronics (for example, security cameras), set top boxes, and/or programmable consumer electronics as part of a network. The computer system/server 10 may be described in the general context of computer system executable instructions, such as program modules, being executed by a computer system (described for example, below). In some embodiments, the computer system/server 10 may be a cloud computing node connected to a cloud computing network (not shown). The computer system/server 10 may be practiced in distributed cloud computing environments where tasks are performed by remote processing devices that are linked through a communications network. In a distributed cloud-computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

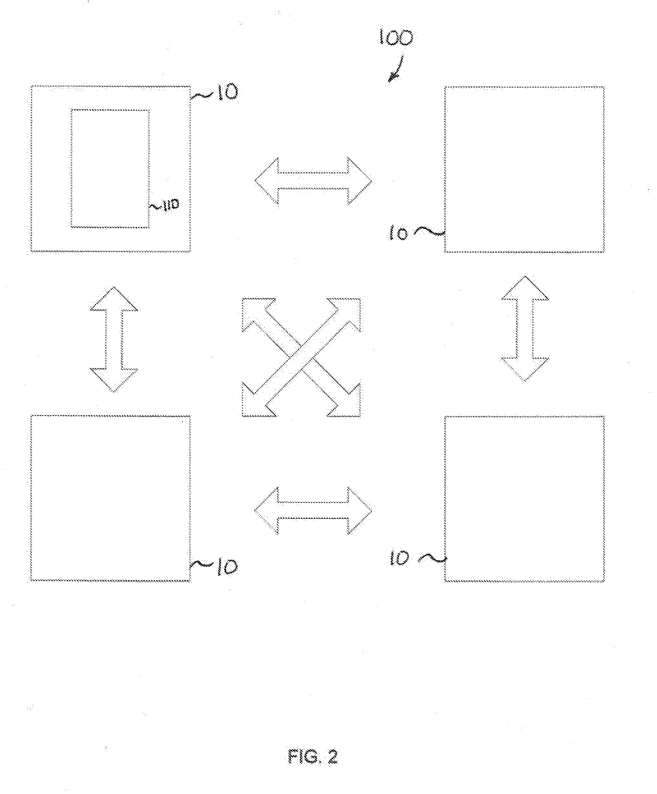

Referring now to FIG. 2, a network system 100 generally provides a network of computer systems/servers 10 connected together. For sake of illustration, only four computer systems/servers 10 are shown however it will be understood that more computer systems/servers 10 may be present in the network system 100. Each computer system/server 10 may be an independent member node in the network 100 and may receive/transfer data to each other member node (computer system/server 10) in the network. It will be understood that some of the computer systems/servers 10 may be part of a distributed ledger networks, while some may communicate with the computer systems/servers 10 in a distributed ledger from outside. Since the software that comprises the distributed ledger are peer2peer, the network architecture can allow for the transfer of the actual digital media file 110 between users or storage within the distributed ledger. Various operations of securing a digital media file 110, verifying that copies of a digital media fie are authentic, and identifying authentic digital media files for the content and metadata therein are described in the processes that follow.

For the following processes, the steps may be performed automatically or by user control, and are generally performed by a processing unit unless otherwise stated.

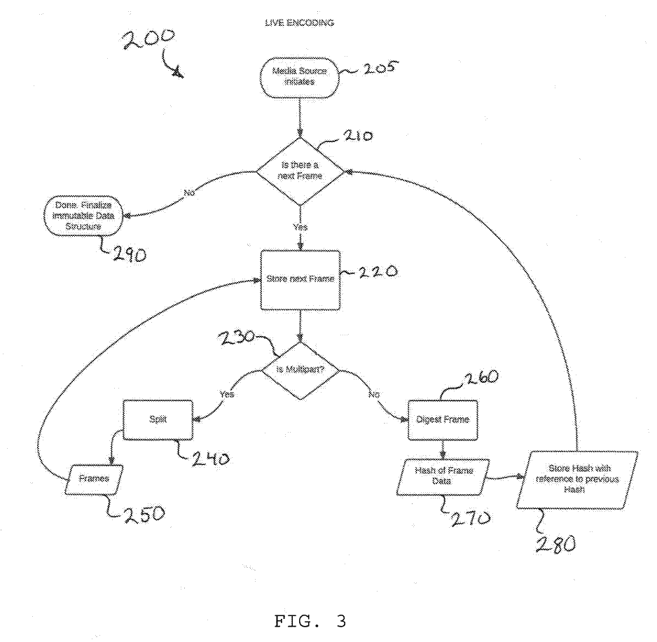

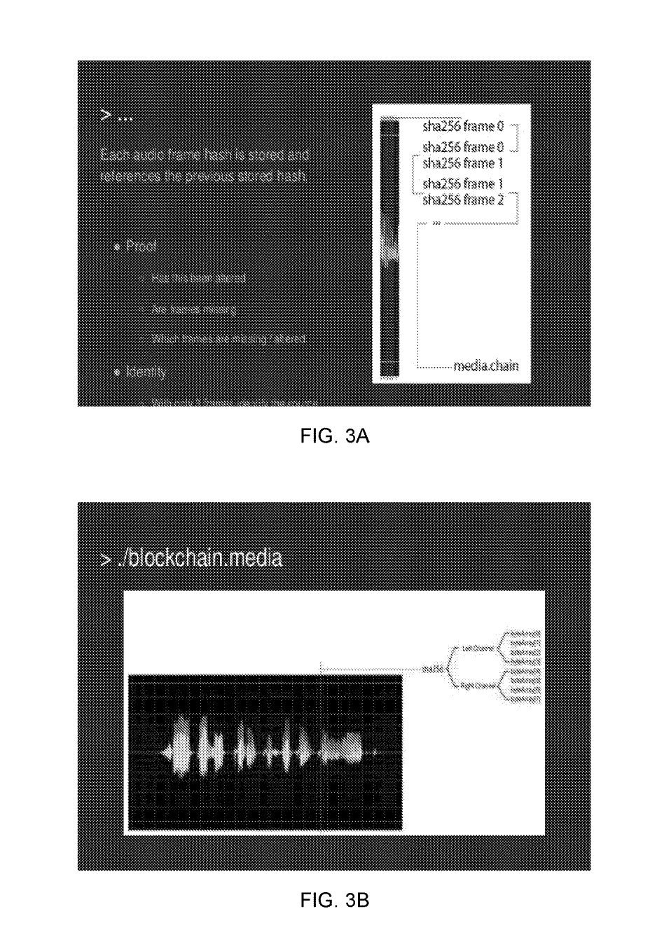

Referring now to FIG. 3, a method 200 for cryptographically securing digital media file contents is shown according to an exemplary embodiment. A media source (for example, a computer system/server 10), initiates 205 the process. A digital media file is selected for securing the content therein. The selection may be performed automatically by hardware or manually by a person at a device as described above. In general, the process generates and integrates a hash function to the selected digital media file. In some embodiments, as the file is being generated, (for example, as a video is being recorded by a camera), the file may be hashed simultaneously with the recording. A hash program may analyze each frame. Each frame is read as bytes into memory. The bitstream, bytearray, or bitmap is transformed using the hashing method of the program. For example: “Sha256(bytes of the frame)”. An example of hashing over an audio file is shown in FIG. 3A. Hashes are “deterministic” so any computer performing a hashing operation over the same source will arrive at the same result. As frames are embedded with a hash value according to the hash function, a determination 210 is made as to whether another frame needs to be hashed. In an exemplary embodiment, successive frames are hashed, however some embodiments may be able to hash a file with one or more frames in the sequence omitted. A simplified example of a 3 frame hash chain might looks like:

frame1: hash: 0x94856 . . . , previous: 0x0

frame2: hash: 0x48362 . . . , previous: 0x94856 . . .

frame3: hash: 0x84772 . . . , previous: 0x48362 . . .

When frames remain to be hashed, a next frame undergoes the storing 220 process for the hash value. A determination 230 may be performed as to whether the selected frame is multipart. In the event a multipart frame is selected, the parts of the frame me be split 240 into segments that may each have their own hash value resulting in newly defined frames 250. An example of hashing over a multi-part audio file is shown in FIG. 3B. Hashing is performed for input from the right and left channels, which may be used to generate the hash of the entire file. If a selected frame is not multipart, the frame may be digested 260 and is hashed 270 with frame data generating a hash value. The selected frame's hash value may be stored 280 referencing the previous frame's hash value so that in the verification process, successive frames form a hash chain which may be checked in comparison to each other to determine compliance. The process may continue until there are no longer any frames remaining to be hashed. Once frames are done being hashed, the collection of hashed frames may itself be hashed representing the original, unaltered version of the digital media file. In some embodiments, the hash chain may be saved as a time stamped immutable record. The hash chain is stored to a trusted source and the process ends 290. While the foregoing was described in the context of all frames in a digital media file being hashed, some embodiments' hash function may select only a portion of the digital media file to be hashed and thus the determination at block 210 may result in the process ending 290 once a frame for the hashed portion of the file is processed.

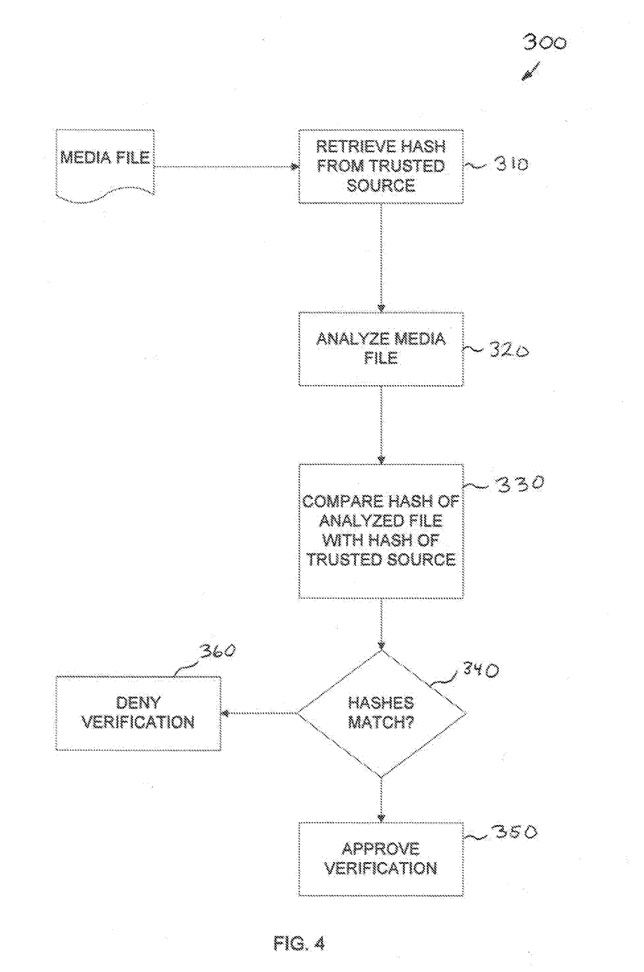

Referring now to FIG. 4, a method 300 for verifying the authenticity of digital media file contents is shown according to an exemplary embodiment. For a given digital media file, (for example, one supplied by another device and accessed/purchased through a network), a hash chain associated with the digital media file may be retrieved 310 from a trusted source. In some embodiments, the digital media file may be a copy of an original, unaltered file and is being evaluated for modification. In some embodiments, the media file under analysis may be original and the predicted hash value for its content it compared to a secure hash function. In some embodiments, the retrieved hash chain might be a record on a distributed ledger. The hash chain might be a separate file or may be embedded inside a copy of the media file. In other embodiments, the hash chain might be stored elsewhere and retrieved (like an online registry). A hashing program analyzes 320 the digital media file obtained to generate a hash for media file being evaluate for authenticity. The hashing program is not necessarily the same program used to secure the digital media file, however it should perform the same operations over the media file and its frames to provide the same hash values. The resulting generated hash chain is compared 330 with the hash chain acquired from the trusted source. A determination 340 is performed to verify if the hash chains match. Any modifications to the digital media file would result in a divergence between the two hash chains being compared. A modification might be for example, an alteration to a frame, an omission of frames, or a reordering of frames. If the hashed match, the media file is approved 350. Otherwise, its authenticity may be denied 360.

As will be appreciated, many applications may benefit from aspects of the verification process. For example, the integrity of video footage which may be used as evidence may be authenticated using the aspects described herein. A police bodycam or vehicle dashcam (autonomous vehicle or human driven) might contain a chip designed to use embodiments described under license. As the cameras record footage the hashchain is embedded into the file and alternatively stored in some protected space within the camera. If the video is needed as evidence for some event, the secure storage of the camera can be queried by some third party and used to authenticate the footage supplied as evidence. This verification will prove the chain of custody did not compromise the footage at any stage (no one removed frames that would convict or exculpate an accused of wrongdoing or no one modified footage or “enhanced” it).

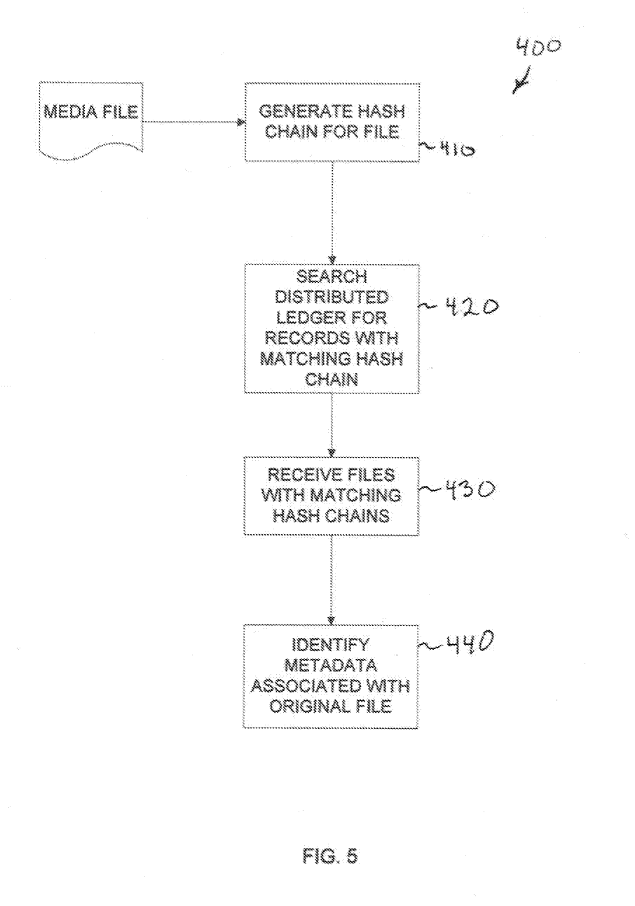

Referring now to FIG. 5, a method 400 for identifying authentic digital media files from a distributed ledger network is shown according to an exemplary embodiment. For a given digital media file, (for example, one supplied by another device and accessed/purchased through a network), a hash chain may be generated 410 for the file. From the generated hash chain, 2 or more frames may be compared against a hash chain from a trusted source to verify authenticity of the file. For example, for a 20 second segment of audio, a hash chain is generated from the audio. A search 420 of a distributed ledger may be performed for any records with segments that matched the generated hash chain. A list of media files that had these exact 20 seconds of audio secured on the ledger may be received 430. The list of matching files may indicate that the given file evaluated is original and unaltered, thus inferring that the content and information therein is reliable. Any information recorded about the original media secured may be identified 440. For example, metadata related to: the original author; the digital rights holder; any derivative works; name of the original file; and/or other meta data related to the original media file.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method for verifying the authenticity of digital media file contents, comprising:
hashing a plurality of frames of an original, unaltered digital media file to generate a plurality of hash values associated with the original, unaltered digital media file;
generating a hash chain from the hashed plurality of frames, the hash chain associated with the original, unaltered digital media file;
storing the generated hash chain in a distributed ledger network;
hashing a digital media file copy;
receiving a copy of the stored hash chain from the distributed ledger network;
comparing the hashed digital media file copy with the received copy of the stored hash chain from the distributed ledger network;
determining whether the hashed digital media file copy matches the received copy of the stored hash chain from the distributed ledger network; and
verifying an authenticity of the hashed digital media file copy as an unaltered copy of the original, unaltered file.

2. The method of claim 1, further comprising:
hashing only a portion of the digital media file copy;
searching the distributed ledger network for other copies of digital media files with portions that match the hashed portion of the digital media file copy; and
verifying other copies of digital media files with portions that match the hashed portion of the digital media file copy as authentic.

3. The method of claim 2, further comprising providing metadata identifying information from the original, unaltered file.

4. The method of claim 1, further comprising recording the original, unaltered digital media file and hashing the plurality of frames simultaneously.

5. The method of claim 1, wherein the hashing of the plurality of frames from the original, unaltered digital media file is performed on successive frames.

6. The method of claim 1, wherein the hash chain is stored in the distributed ledger network as a time-stamped, immutable record.

7. The method of claim 1, wherein the hash chain is embedded in the original, unaltered digital media file.

8. A computer program product for verifying the authenticity of digital media file contents, the computer program product comprising a non-transitory computer readable storage medium having computer readable program code embodied therewith, the computer readable program code being configured, when executed by a computer processor, to:
hash a plurality of frames of an original, unaltered digital media file to generate a plurality of hash values associated with the original, unaltered digital media file;
generate a hash chain from the hashed plurality of frames, the hash chain associated with the original, unaltered digital media file;
store the generated hash chain in a distributed ledger network;
hash a digital media file copy;
receive a copy of the stored hash chain from the distributed ledger network;
compare the hashed digital media file copy with the received copy of the stored hash chain from the distributed ledger network;
determine whether the hashed digital media file copy matches the received copy of the stored hash chain from the distributed ledger network; and
verify an authenticity of the hashed digital media file copy as an unaltered copy of the original, unaltered file.

9. The computer program product of claim 8, further comprising computer readable program code configured to:
hash only a portion of the digital media file copy;
search the distributed ledger network for other copies of digital media files with portions that match the hashed portion of the digital media file copy; and
verify other copies of digital media files with portions that match the hashed portion of the digital media file copy as authentic.

10. The computer program product of claim 9, further comprising computer readable program code configured to provide metadata identifying information from the original, unaltered file.

11. The computer program product of claim 8, further comprising computer readable program code configured record the original, unaltered digital media file and hashing the plurality of frames simultaneously.

12. The computer program product of claim 8, wherein the hashing of the plurality of frames from the original, unaltered digital media file is performed on successive frames.

13. The computer program product of claim 8, wherein the hash chain is stored in the distributed ledger network as a time-stamped, immutable record.

14. The computer program product of claim 8, wherein the hash chain is embedded in the original, unaltered digital media file.

15. A computer server system for verifying the authenticity of digital media file contents, comprising:
a non-transitory computer readable storage medium having computer readable program code; and
a processing unit configured to, according to the computer readable code:
hash a selected digital media file copy;
receive a copy of a stored hash chain from a distributed ledger network;
compare the hashed digital media file copy with the received copy of the stored hash chain from the distributed ledger network;
determine whether the hashed digital media file copy matches the received copy of the stored hash chain from the distributed ledger network; and
verify an authenticity of the hashed digital media file copy as an unaltered copy of an original, unaltered file.

16. The computer server of claim 15, wherein the processing unit is further configured to, according to the computer readable code:
hash only a portion of the selected digital media file copy;
search the distributed ledger network for other copies of digital media files with portions that match the hashed portion of the selected digital media file copy; and
verify other copies of digital media files with portions that match the hashed portion of the selected digital media file copy as authentic.

17. The computer server of claim 15, wherein the processing unit is further configured to, according to the computer readable code, provide metadata identifying information from the original, unaltered file in response to the verified authenticity of the hashed digital media file copy.
